(19) United States
(12) Patent Application Publication
(10) Pub. No.: US 2015/0007036 A1
(43) Pub. Date: Jan. 1, 2015

(54) ELECTRONIC DEVICE FOR SHARING QUESTION MESSAGE AND METHOD OF CONTROLLING THE ELECTRONIC DEVICE

(71) Applicant: Samsung Electronics Co., Ltd., Suwon-si (KR)

(72) Inventors: Pyeong-Gyu JIN, Suwon-si (KR); Yoon-Jeong CHOI, Seoul (KR)

(21) Appl. No.: 14/315,497

(22) Filed: Jun. 26, 2014

(30) Foreign Application Priority Data
Jun. 27, 2013 (KR) 10-2013-0074476

(51) Int. Cl. G06F 3/0484; H04L 29/08

(52) U.S. Cl. CPC G06F 3/0484; H04L 67/10
USPC 715/733

(57) ABSTRACT

A method of controlling a host electronic device that shares a question message with a client electronic device is provided. The method includes running an application to be shared with the client electronic device and generating shared data that includes a running screen of the application, sending the shared data to the client electronic device, receiving a question message from the client electronic device, the question message including content of a question regarding the application, and displaying the question message.

### CROSS-REFERENCE TO RELATED APPLICATION(S)

This application claims the benefit under 35 U.S.C. §119(a) of a Korean patent application filed on Jun. 27, 2013 in the Korean Intellectual Property Office and assigned Serial No. 10-2013-0074476, the entire disclosure of which is hereby incorporated by reference.

### TECHNICAL FIELD

The present disclosure relates to an electronic device for sharing a message and method of controlling the electronic device. More particularly, the present disclosure relates to an electronic device for sharing a message based on a predetermined communication scheme and method of controlling the electronic device.

### BACKGROUND

Smartphones, mobile terminals, portable electronic devices, tablet Personal Computers (PCs), and other such electronic devices, are rapidly spreading these days, and typically include camera modules for users to capture images. Images captured by the camera module may be stored in the electronic device. The user can load a stored image at any time and manipulate his/her electronic device to display the image on the screen.

With the increase of smartphone, tablet phone, and other similar electronic device usage, people participating in a presentation, an E-meeting, a video conference, or other similar events, may receive content with their electronic devices. For example, during the presentation, E-meeting, or video conference, speakers and listeners may share their data and exchange information using their electronic devices. More specifically, the speaker may manipulate his/her electronic device to share a question in the form of a simple text comment received through a predetermined interface and display/answer to the question.

A conventional E-meeting or video conference suffers from uneven time scheduling due to unexpected increase or decrease in speaking time, such as in a case of a Question & Answer (Q & A) session. It is also possible that the speaker may waste time on wrong presentation data and preparation for an answer to a question due to unawareness of how important the question is even if the answer is already suggested in presentation data. Furthermore, due to a half-hearted attitude of the audience, i.e., in a case where the audience is not or cannot pay attention to a presentation, the meeting may be over before participants fully understand the presentation data.

Therefore, there is a need for an electronic device for sharing question messages marked with priorities and method of controlling the electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device for sharing a question message and method of controlling the electronic device.

In accordance with an aspect of the present disclosure, a method of controlling a host electronic device that shares a question message with a client electronic device is provided. The method includes running an application to be shared with the client electronic device and generating shared data that includes a running screen of the application, sending the shared data to the client electronic device, receiving a question message from the client electronic device, the question message including content of a question regarding the application, and displaying the question message.

In accordance with another aspect of the present disclosure, a host electronic device that shares a question message with a client electronic device is provided. The host electronic device includes a controller configured to execute an application to be shared with the client electronic device and configured to generate shared data that includes a running screen of the application, a communication unit configured to send the shared data to the client electronic device and configured to receive a question message from the client electronic device that includes content of a question regarding the application, and a touch screen for displaying the question message.

In accordance with another aspect of the present disclosure, a method of controlling a client electronic device that shares a question message with a host electronic device is provided. The method includes receiving shared data that includes a running screen of an application to be shared, the application running in the host electronic device, outputting the shared data, and displaying an icon to create a question message which is configured to provide a user interface for creating a question message regarding the shared data.

In accordance with another aspect of the present disclosure, a client electronic device for sharing a question message with a host electronic device is provided. The client electronic device includes a communication unit configured to receive shared data that includes a running screen of an application to be shared, the application running in the host electronic device, a touch screen configured to output the shared data, and a controller configured to display an icon to create a question message which is configured to provide a user interface for creating a question message regarding the shared data.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic block diagram illustrating an electronic device according to an embodiment of the present disclosure;

FIG. 2 illustrates application sharing according to an embodiment of the present disclosure;

FIG. 3 illustrates screens displayed by electronic devices according to an embodiment of the present disclosure;

FIG. 4 is a flowchart illustrating operation of host and client electronic devices according to an embodiment of the present disclosure;

FIG. 5 is a flowchart illustrating operation of a method of controlling a client electronic device according to an embodiment of the present disclosure;

FIG. 6 illustrates a screen of a user interface according to an embodiment of the present disclosure;

FIG. 7 is a flowchart illustrating operation of a method of controlling a host electronic device according to an embodiment of the present disclosure;

FIG. 8 is a flowchart illustrating operation of a method of controlling a client electronic device according to another embodiment of the present disclosure;

FIG. 9 is a flowchart illustrating operation of a method of controlling a host electronic device according to another embodiment of the present disclosure;

FIGS. 10A, 10B, and 10C illustrate icons to indicate reception of a question according to embodiments of the present disclosure;

FIG. 11 illustrates a screen for explaining a way of displaying a question message according to an embodiment of the present disclosure; and

FIG. 12 illustrates electronic devices according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those if ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not be limited the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural references unless the context clearly dictates otherwise. Thus, for example, reference to “a component surface” includes reference to one or more of such surfaces.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

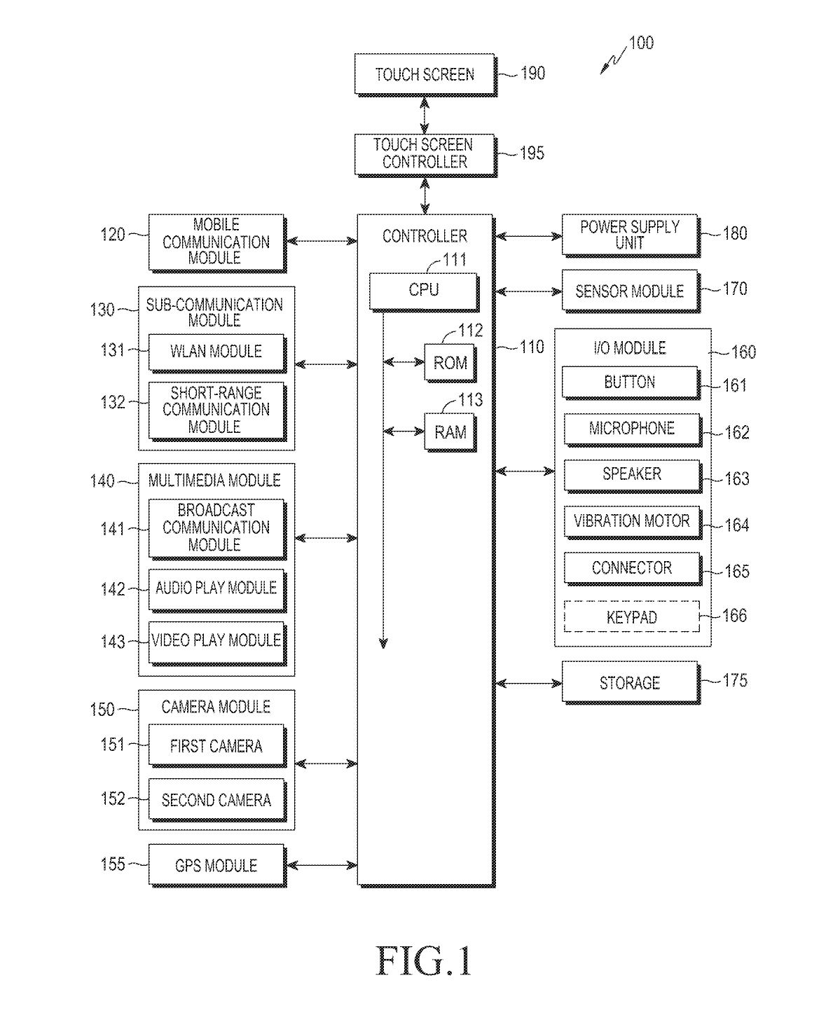

FIG. 1 is a schematic block diagram illustrating an electronic device, according to an embodiment of the present disclosure.

Referring to FIG. 1, an electronic device 100 may be connected to an external device (not shown) by using an external device connection, such as a sub-communication module 130, a connector 165, and a headset jack (not shown). The external device may include a variety of devices, such as earphones, external speakers, Universal Serial Bus (USB) memory, chargers, cradles, docking stations, Digital Multimedia Broadcasting (DMB) antennas, payment related devices, health care devices (e.g., blood sugar testers), game consoles, vehicle navigation devices, or any other similar and/or suitable devices which are removably attached to the electronic device 100 via cable. The external device may also include a short range communication device that may be wirelessly connected to the electronic device 100 via a short range communication system, such as Bluetooth, Near Field Communication (NFC), and any other similar and/or suitable short range communication system, and any other communication device, such as a Wireless Fidelity (WiFi) Direct communication device, a wireless Access Point (AP), or any other similar and/or suitable communication device. Furthermore, the external device may include any other device, such as a cell phone, smartphone, tablet Personal Computer (PC), desktop PC, a server, or any other similar and/or suitable electronic device.

While a mobile device may be taken as an example of the electronic device 100, the electronic device 100 may be a tablet Personal Computer (PC), a desktop PC, a smart Television (TV), a notebook, a music player, a Motion Picture Experts Group (MPEG) Audio Layer 3 (MP3) player, or any other similar and/or suitable electronic device.

Referring to FIG. 1, the electronic device 100 includes a touch screen 190 and a touch screen controller 195. The electronic device 100 also includes a controller 110, a mobile communication module 120, the sub-communication module 130, a multimedia module 140, a camera module 150, a Global Positioning System (GPS) module 155, an input/output module 160, a sensor module 170, a storage 175, and a power supply 180. The sub-communication module 130 includes at least one of a Wireless Local Area Network (WLAN) module 131 and a short-range communication module 132, and the multimedia module 140 includes at least one of a broadcast communication module 141, an audio play module 142, and a video play module 143. The camera module 150 includes at least one of a first camera 151 and a second camera 152, and the input/output module 160 includes at least one of button 161, a microphone 162, a speaker 163, a vibration motor 164, a connector 165, a keypad 166, and a headset jack (not shown).

The controller 110 may include a Central Processing Unit (CPU) 111, a Read Only Memory (ROM) 112 for storing a control program to control the electronic device 100, and a Random Access Memory (RAM) 113 for storing at least one of signals and data input from an outside and for being used as a memory space for working results in the electronic device 100. The CPU 111 may include a single core, dual cores, triple cores, quad cores, or any suitable number of cores. The CPU 111, ROM 112, and RAM 113 may be connected to each other via an internal bus.

The controller 110 may control the mobile communication module 120, the sub-communication module 130, the multimedia module 140, the camera module 150, the GPS module, the input/output module 160, the sensor module 170, the storage 175, the power supply 180, the touch screen 190, and the touch screen controller 195.

The mobile communication module 120 connects the electronic device 100 to an external device through mobile communication using at least one antenna (not shown) under control of the controller 110. The mobile communication module 120 transmits and/or receives wireless signals for voice calls, video conference calls, Short Message Service (SMS) messages, or Multimedia Message Service (MMS) messages to and/or from a cell phone (not shown), a smart phone (not shown), a tablet PC (not shown), or another device (not shown), the phones having phone numbers entered into the electronic device 100.

The sub-communication module 130 may include at least one of the WLAN module 131 and the short-range communication module 132. For example, the sub-communication module 130 may include either the WLAN module 131 or the-short range communication module 132, both, and any other similar and/or suitable communication module.

The WLAN module 131 may be connected to the Internet in a place where there is a wireless Access Point (AP) (not shown), under control of the controller 110. The WLAN module 131 supports Institute of Electrical and Electronic Engineers' (IEEE's) WLAN standard IEEE 802.11x. The short-range communication module 132 may perform short-range communication between the electronic device 100 and an image rendering device (not shown), or any other similar and/or suitable electronic device, under control of the controller 110. The short-range communication may include Bluetooth, Infrared Data Association (IrDA), WiFi-Direct, NFC, and any other similar and/or suitable short-range communication method.

The electronic device 100 may include at least one of the mobile communication module 120, the WLAN module 131 and the short-range communication module 132 based on the performance of the electronic device 100. For example, the electronic device 100 may include a combination of the mobile communication module 120, the WLAN module 131 and the short-range communication module 132 based on the performance of the electronic device 100.

The multimedia module 140 may include at least one of the broadcast communication module 141, the audio play module 142, and the video play module 143. The broadcast communication module 141 may receive broadcast signals, e.g., television broadcast signals, radio broadcast signals, or data broadcast signals, and additional broadcast information, e.g., an Electric Program Guide (EPG) and an Electric Service Guide (ESG)), transmitted from a broadcasting station through a broadcast communication antenna (not shown), under control of the controller 110. The audio play module 142 may play digital audio files, e.g., files having extensions, such as mp3, wma, ogg, or way, stored or received under control of the controller 110. The video play module 143 may play digital video files, e.g., files having extensions, such as mpeg, mpg, mp4, avi, move, or mkv, stored or received under control of the controller 110. The video play module 143 may also play digital audio files.

According to an embodiment of the present disclosure, the multimedia module 140 may include the audio play module 142 and the video play module 143 except for the broadcast communication module 141. The audio play module 142 or video play module 143 of the multimedia module 140 may be included in the controller 110.

The camera module 150 may include at least one of the first and second cameras 151 and 152 for capturing still images or video images under control of the controller 110. Furthermore, the first or second camera 151 or 152 may include an auxiliary light source, e.g., a flash (not shown), for providing as much an amount of light for capturing an image. The first camera 151 may be placed on the front of the electronic device 100 and the second camera 152 may be placed on the back of the electronic device 100. Alternatively, the first and second cameras 151 and 152 may be arranged adjacent to each other, e.g., the distance between the first and second cameras 151 and 152 may be within the range between 1 to 8 cm, or any suitable and/or similar distance, in order to capture 3D still images or 3D video images, or may be disposed according to any similar and/or suitable position.

The GPS module 155 receives radio signals from a plurality of GPS satellites (not shown) in Earth's orbit, and may calculate the position of the electronic device 100 by using time of arrival from the GPS satellites to the electronic device 100.

The input/output module 160 may include the at least one button 161, the microphone 162, the speaker 163, the vibration motor 164, the connector 165, and the keypad 166.

The at least one button 161 may be arranged on the front, side, top, bottom, or back of the housing of the electronic device 100, and may include, although not shown, at least one of a power/lock button, a volume button, a menu button, a home button, a back button, a search button, and any other similar and/or suitable button type.

The microphone 162 generates electric signals from received a voice or sound source under control of the controller 110.

The speaker 163 may output sounds corresponding to various signals, e.g., radio signals, broadcast signals, digital audio files, digital video files and photography signals, from the mobile communication module 120, the sub-communication module 130, the multimedia module 140, or the camera module 150 to the outside under control of the controller 110. The speaker 163 may output sounds, e.g., button-press sounds or ringback tones, which correspond to functions performed by the electronic device 100. There may be one or multiple speakers 163 arranged in a proper position or positions of the housing of the electronic device 100.

The vibration motor 164 may convert an electric signal into a mechanical vibration under control of the controller 110. For example, the electronic device 100 in a vibrating mode drives the vibration motor 164 when receiving a voice call from another device (not shown). There may be one or more vibration motors 164 inside of the housing of the electronic device 100. The vibration motor 164 may be driven in response to a touch activity or continuous touches of a user on and/or over the touch screen 190.

The connector 165 may be used as an interface for connecting the electronic device 100 to the external device (not shown) or a power source (not shown). Under control of the controller 110, the electronic device 100 may transmit data stored in the storage 175 of the electronic device 100 to the external device via a cable connected to the connector 165, or may receive data from the external device. The external device may be a docking station and the data may be an input signal received from the external device and/or an input signal received from another device, e.g., a mouse, a keyboard, or the like, connected to the external device. Furthermore, the electronic device 100 may be powered by the power source via a cable connected to the connector 165 or may charge the battery (not shown) with the power source.

The keypad 166 may receive key inputs from the user to control the electronic device 100. The keypad 166 may include a physical keypad (not shown) formed in the electronic device 100 and a virtual keypad (not shown) displayed on the touchscreen 190. The physical keypad formed in the electronic device 100 may be excluded depending on the performance or structure of the electronic device 100.

A headset (not shown) may be inserted into the headset jack and connected to the electronic device 100.

The sensor module 170 includes at least one sensor for detecting a status of the electronic device 100. For example, the sensor module 170 may include a proximity sensor to detect the proximity of the user to the electronic device 100 and a light sensor to detect an amount of ambient light of the electronic device 100. The sensor module 170 may also include a gyroscopic sensor. The gyroscopic sensor may detect operations and/or movement of the electronic device 100, e.g., a rotation, an acceleration, a vibration, or any other similar and/or suitable movement of the electronic device 100, may detect points of a compass using the Earth's magnetic field, and may detect a direction of gravity. The sensor module 170 may also include an altimeter to detect an altitude by measuring atmospheric pressure. At least one sensor may detect the status and generate a corresponding signal to transmit to the controller 110. The sensor of the sensor module 170 may be added or removed depending on the performance of the electronic device 100.

The storage 175 may store signals or data input/output according to operations of the mobile communication module 120, the sub-communication module 130, the multimedia module 140, the camera module 150, the GPS module 155, the input/output module 160, the sensor module 170, and the touch screen 190 under control of the controller 110. The storage 175 may store the control programs and applications for controlling the electronic device 100 or the controller 110.

The term “storage” implies not only the storage 175, but also the ROM 112, RAM 113 in the controller 110, or a memory card (not shown), e.g., an Secure Digital (SD) card, a memory stick, or other similar and/or suitable memory card, installed in the electronic device 100. The storage may also include a non-volatile memory, a volatile memory, a Hard Disc Drive (HDD), a Solid State Drive (SSD), or any other similar and/or suitable hardware storage device for storing information.

The power supply 180 may supply power to one or more batteries (not shown) placed inside the housing of the electronic device 100 under control of the controller 110. The one or more batteries power the electronic device 100. The power supply 180 may supply the electronic device 100 with the power input from the external power source (not shown) via a cable connected to the connector 165. The power supply 180 may also supply the electronic device 100 with wireless power from an external power source using a wireless charging technology.

The touch screen 190 may provide the user with a user interface for various services, e.g., call services, data transmission services, broadcasting services, photography services, and any similar and/or suitable services. The touchscreen 190 may send an analog signal corresponding to at least one touch input to the user interface to the touchscreen controller 195. The touch screen 190 may receive the at least one touch from the user's physical contact, e.g., with fingers or a thumb, or via a touchable input device, e.g., a stylus pen. The touchscreen 190 may receive consecutive movements of one of the at least one touch. The touch screen 190 may send an analog signal corresponding to the consecutive movements of the input touch to the touchscreen controller 195.

The term “touch”, as used herein, is not limited to the user's physical contact or touchable input device's contact but may include contactless touches, contactless gestures, or any other similar and/or suitable input gesture made by a user of the electronic device 100. The detectable distance from the touch screen 190 may vary depending on the performance or structure of the electronic device 100.

The touch screen 190 may be implemented in various ways, such as in a resistive, capacitive, Electronic Magnetic Resonance (EMR), infrared, and acoustic wave scheme, or a combination thereof.

The touch screen controller 195 converts the analog signal received from the touch screen 190 to a digital signal, e.g., (X,Y) coordinates, and transmits the digital signal to the controller 110. The controller 110 may control the touch screen 190 by using the digital signal received from the touch screen controller 195. For example, in response to the touch, the controller 110 may enable a shortcut icon (not shown) displayed on the touchscreen 190 to be selected or to be executed. The touch screen controller 195 may also be incorporated in the controller 110.

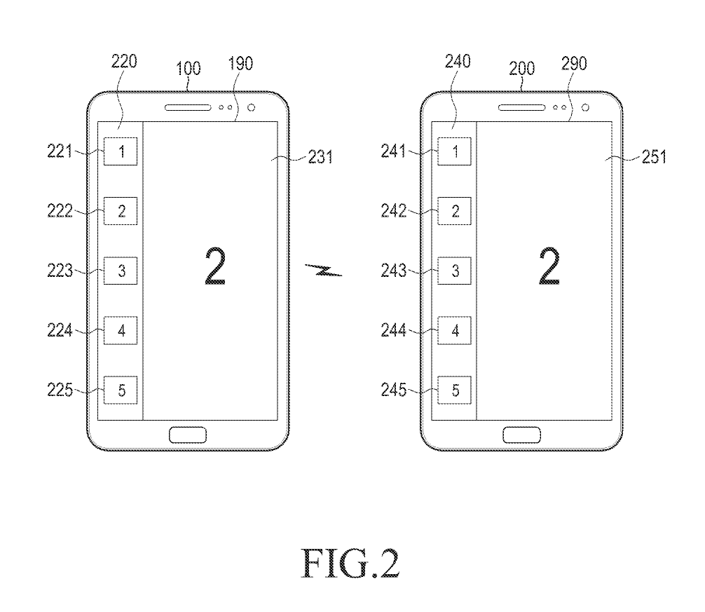

FIG. 2 illustrates application sharing, according to an embodiment of the present disclosure.

Referring to FIG. 2, a first electronic device which is the electronic device 100 and a second electronic device 200 may share data. For example, the first electronic device 100 may display application running screens 220 and 231 of an application related to a meeting or conference. The application running screens 220 and 231 may display information corresponding to applications that are running, or in other words, applications that are currently being executed on the electronic device 200 or any other electronic device. The first electronic device 100 may install and run an application that includes at least one slide for the meeting, such as a slide of a presentation to be given and displayed in the meeting or conference. For example, the application may include the application running screen 220, which may be referred to as a slide list 220 of at least one slide 221 to 225 and the application running screen 231, which may be referred to as a display screen 231 for one of the at least one slide 221 to 225. In an embodiment of FIG. 2, the first electronic device 100 may present the display screen 231 for a second slide 222 among the at least one slide 221 to 225. If the user selects another slide, than the second slide 222, then the first electronic device 100 may replace the display screen 231 for the second slide 222 with a display screen for the other slide selected by the user.

The first electronic device 100 may send shared data, including data corresponding to the application running screens 220 and 231, to the second electronic device 200. The second electronic device 200 may receive and output the shared data. For example, the second electronic device 200 may display application running screens 240 and 251. The application running screens 240 and 251 may be substantially the same as the application running screens 220 and 231 of the first electronic device 100, and slides 241 to 245 may be similar to slides 221 to 225. Additionally, a touch screen 290 of the second electronic device 200 may be similar to the touch screen 190 of the first electronic device 100. Alternatively, the application running screens 240 and 251 may be a modified version of the application running screens 220 and 231 of the first electronic device 100. For example, as will be described in more detail later, the second electronic device 200 may further display an icon to create a question message.

The first electronic device 100 that runs and shares an application with other electronic devices may be herein referred to as a ‘host’ electronic device. The second electronic device 200 that receives and outputs the shared data related to the application from the host electronic device 100 may be herein called a ‘client’ electronic device.

As such, the first and second electronic devices 100 and 200 may share an application running screen with each other. A speaker and a participant, e.g., a listener, or participants in a meeting may possess the first and second electronic devices 100 and 200, respectively, and may run the meeting while looking at the same screen on their respective ones of the first and second electronic devices 100 and 200.

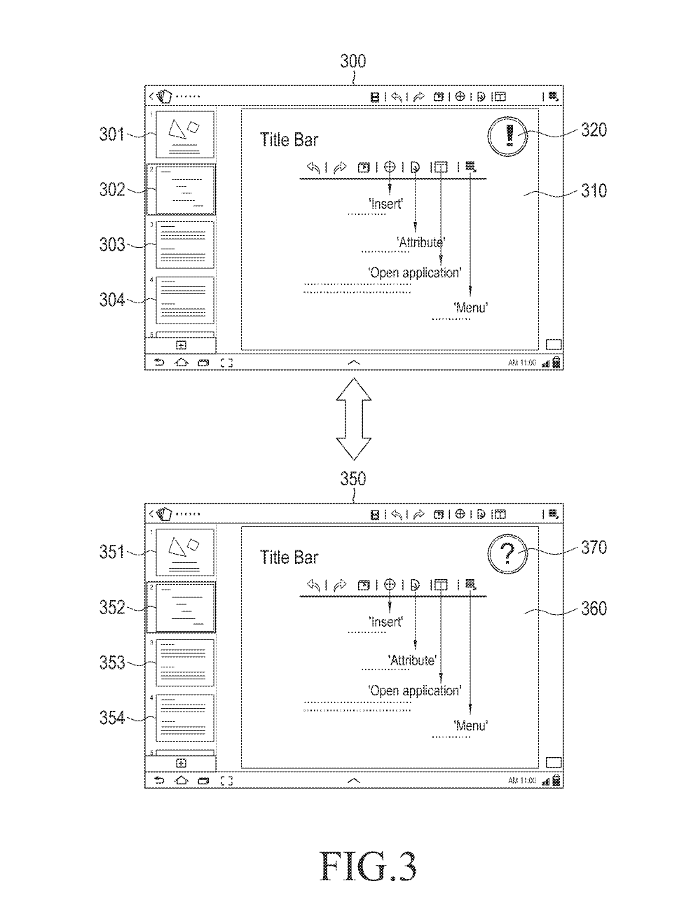

FIG. 3 illustrates screens displayed by electronic devices, according to an embodiment of the present disclosure.

Referring to FIG. 3, an application running screen 300 may be displayed on the host electronic device 100 with at least one slide 301 to 304 and a screen 310 for displaying one of the at least one slide 301 to 304, which may be the second slide 302 in this example. The host electronic device 100 may display an icon 320, in order to indicate reception of a question, on the screen 310 for the second slide 302. For example, the host electronic device 100 may receive a question message from the client electronic device 200 and may display the icon 320 indicating that the question message has been received.

The host electronic device 100 may display the received question message upon selection of the icon 320. In this regard, the host electronic device 100 may display a slide in which the received question is displayed or may display the received question in a pop-up window. While in the embodiment of FIG. 3 the icon 320 is displayed as a circle having an exclamation mark, it is not limited thereto, and the icon 320 may be displayed in any of other various forms. The host electronic device 100 may display the icon in order to indicate reception of a question in any of other various forms depending on the priority of the received question message, which will be described in detail later.

The client electronic device 200 may display an application running screen 350 displaying the shared data received from the host electronic device 100. For example, the shared data, i.e., the application running screen 350, may include at least one slide 351 to 354 and a screen 360 for displaying one of the at least one slide 351 to 354, which may be the second slide 352 in this example.

The client electronic device 200 may display an icon 370 in order to create a question message on the screen 360. The icon 370 may be set up to provide a user interface that enables the user to create a question message. For example, in an attempt to send a question message to the host electronic device 100, the user of the client electronic device 200 may select the icon 370 to create a question message, and thus may provide the user interface for enabling the user to create a question message. Detailed description of the user interface that enables the user to create a question message may be explained later.

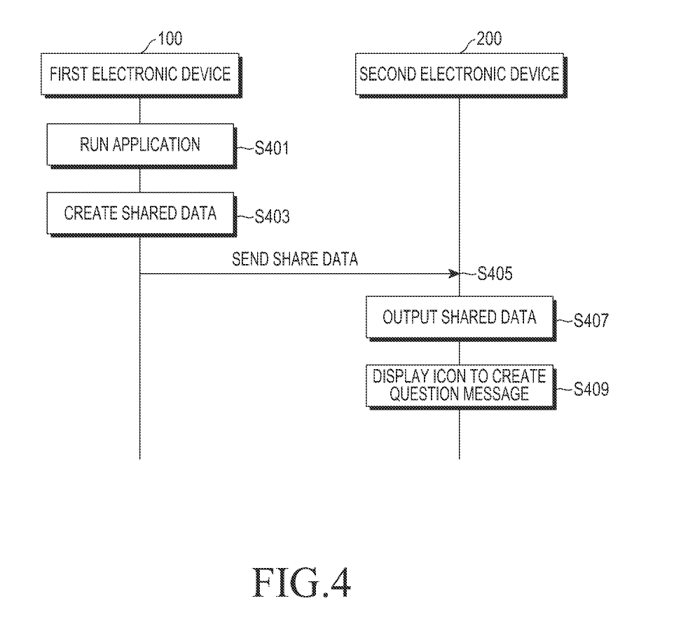

FIG. 4 is a flowchart illustrating operation of host and client electronic devices, according to an embodiment of the present disclosure.

In operation S401, the host electronic device 100 may run an application. The application may correspond to the application for presentation, as shown in FIG. 3. The application may include many objects related to the application. The objects may include various elements, such as text, figures, icons, buttons, checkboxes, photos, videos, webs, maps, and other similar elements used by an application. When the user touches an object, a predetermined function or event assigned for the object may be performed in the application. The object may be called a view in some operating systems.

In operation S403, the host electronic device 100 may generate shared data to be shared with any client. The shared data herein may be an output of the application to be shared. The host electronic device 100 may also generate display data of the application to be shared, and the shared data may include sounds or vibration data output from the application to be shared. Specifically, the host electronic device 100 may not detect the entire data output from itself, but rather, may only detect the data output from the application to be shared as the shared data.

More specifically, the host electronic device 100 may run the application to be shared and perform a surface flinger task, or other similar memory allocation tasks and/or operations, on the application. That is, the host electronic device 100 may detect display data of the application to be shared as the shared data, e.g., before combining the display data with a background screen, or may detect display data of any other application. Alternatively, the host electronic device 100 may detect the combined data as the shared data.

The host electronic device 100 may adjust internal information of the running screen of the application to be shared, which results from the surface flinger task performed on the application to be shared. The host electronic device 100 may adjust internal information based on device information regarding the client electronic device 200. For example, assuming that the client electronic device 200 is a Personal Computer (PC), the host electronic device 100 may adjust a version of the application to be shared to be the PC version. In a case where a resolution of the client electronic device 200 is different from that of the host electronic device 100, the host electronic device 100 may perform conversion of a resolution of the running screen of an application to be shared. However, adjustment of the internal information may be skipped. For example, in a case where the host and client electronic devices 100 and 200 are of the same kind, the adjustment of the internal information may not be made.

As described above, the host electronic device 100 may generate shared data. The host electronic device 100 may select an application screen or an application screen whose internal and/or displayed information is adjusted to be the shared data. The host electronic device 100 may generate the shared data by combining an application screen or an application screen whose internal information is adjusted with other multimedia outputs, such as sounds or vibration.

In operation S405, the host electronic device 100 may send the shared data to the client electronic device 200. Specifically, the host electronic device 100 may send the shared data to the client electronic device 200 based on a short-range communication scheme, such as Bluetooth, Bluetooth low energy, IrDA, WiFi-Direct, NFC, or other similar and/or suitable short-range communication schemes. In another example, the client electronic device 200 may use an accessory to support the WiFi-Direct.

Alternatively, the host electronic device 100 may send the shared data to a relay server (not shown), or other similar and/or suitable network element that receives and transmits data using wireless data communication, and the relay server may forward the shared data to the client electronic device 200. The host electronic device 100 may share an application with the client electronic device 100 even from a distance that exceeds an effective short-range communication range.

Alternatively, the host electronic device 100 may send the shared data to the client electronic device 200 using wired communication. For example, the host electronic device 10 may send the shared data to the client electronic device 200 via a High Definition Multimedia Interface (HDMI) cable or a Universal Serial Bus (USB) cable.

In the embodiment of FIG. 3, the client electronic device 200 is illustrated to show certain data on its display but it is by way of example only, and the embodiments of the present disclosure are not limited thereto. The client electronic device 200 may receive at least one of display data and multimedia data, such as voice or vibration data from the host electronic device 100, and may display resultant data with the multimedia data.

In operation S407, the client electronic device 200 may output the shared data. The client electronic device 200 may output the received shared data intact or may modify the shared data for output based on the device characteristics.

In operation S409, the client electronic device 200 may display an icon to create a question message on the share data. The client electronic device 200 may display a screen by combining the share data with rendering data of the icon to create a question message. Alternatively, the client electronic device 200 may display the shared data and rendering data of the icon to create a question message, separately. For example, upon reception of the shared data, the client electronic device 200 may generate a window for outputting the shared data.

The window may be configured to receive a user command and to send the user command to the host electronic device 100. More specifically, for a user command like a dragging gesture made on the window, the client electronic device 200 may send information, such as input coordinates on the touch screen where the dragging gesture is made, input time of the dragging gesture, a type of the dragging gesture, or any other similar and/or suitable information, to the host electronic device 100. The client electronic device 200 may manage a position to place the icon to create a question message to be displayed on the window and may determine whether the user selects the icon to create a question message. Having determined that the icon to create a question message is selected, the client electronic device 200 may provide a user interface for creating a question message.

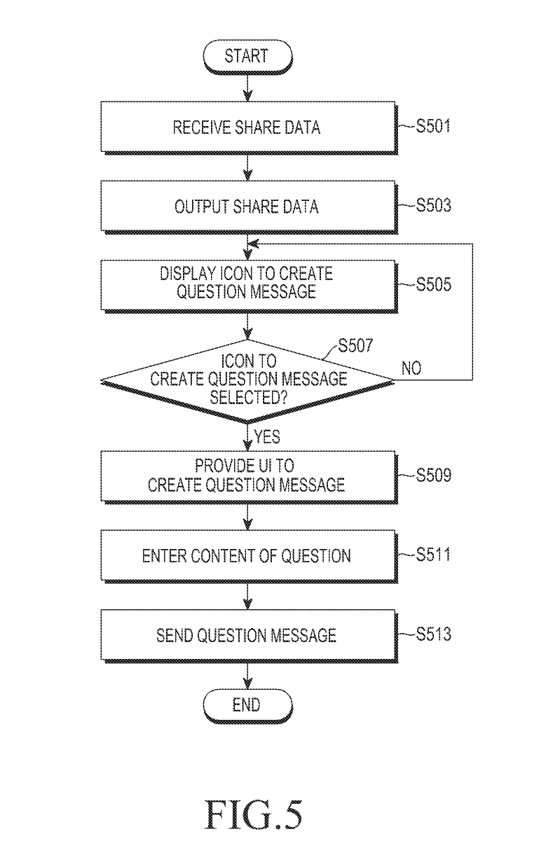

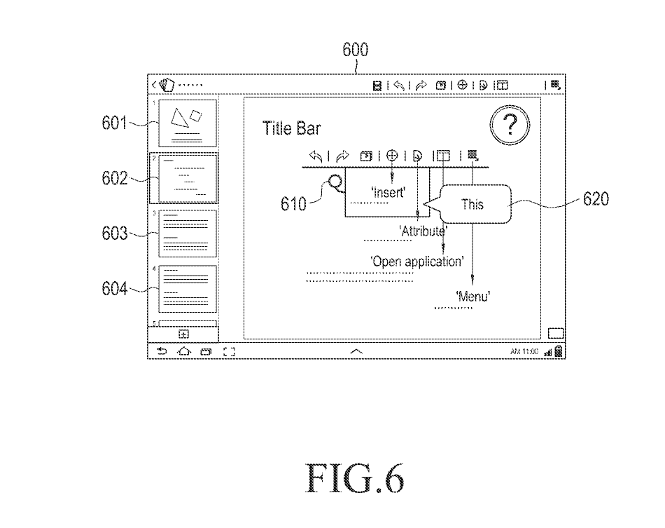

FIG. 5 is a flowchart illustrating operation of a method of controlling a client electronic device, according to an embodiment of the present disclosure; and FIG. 6 illustrates a screen of a user interface according to an embodiment of the present disclosure.

Referring to FIG. 5, in operation S501, the client electronic device 200 may receive shared data, and in operation S503, output the shared data. In operation S505, the client electronic device 200 may display an icon to create a question message with the shared data. In operation S507, the client electronic device 200 may determine whether the icon is selected. Having determined that the icon is selected, in operation S509 client electronic device 200 may provide a user interface for creating a question message.

Referring to FIG. 6, for example, the client electronic device 200 may provide a user interface 600, as shown in FIG. 6. The user interface 600 may include at least one slide 601 to 604. The user may select one of the at least one slide 601 to 604 and manipulate the client electronic device 200 to create a question message regarding the selected slide. The client electronic device 200 may enable any of at least one object displayed in the selected slide to be selected. In an embodiment of FIG. 6, the client electronic device 200 has an “insert” object 610 selected and provides a corresponding window 620 to enter a question. In operation S511, the user may enter content of a question in the window 620 in order to enter the question. In operation S513, the client electronic device 200 may send a question message to the host electronic device 200, the question message including at least one of the selected objects and the content of the question.

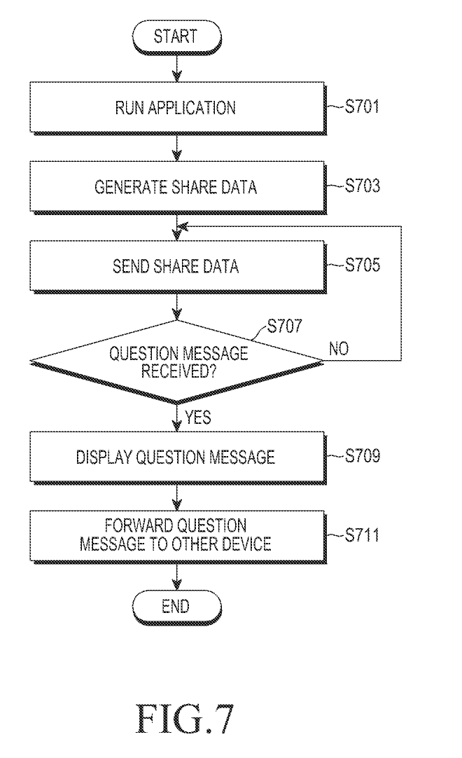

FIG. 7 is a flowchart illustrating operation of a method of controlling a host electronic device, according to an embodiment of the present disclosure.

Referring to FIG. 7, in operation S701, the host electronic device 100 may run an application, and in operation S703 may generate shared data. In operation S705, the host electronic device may send the shared data, and in operation S707 may receive a question message. Upon reception of the question message in operation S707, the host electronic device 100 may display the question message in operation S709. For example, the host electronic device 100 may newly generate a slide that reflects the question message, and may display the slide with the question message if the slide is selected. Alternatively, the host electronic device 100 may display the question message in a pop-up window.

In operation S711, the host electronic device 100 may forward the question message to any other device. That is, the host electronic device 100 may forward the question message to client electronic devices other than the client electronic device 200 from which the question message is originated. The other client electronic devices may then display the received question message, so that participants in the meeting may all share the question message.

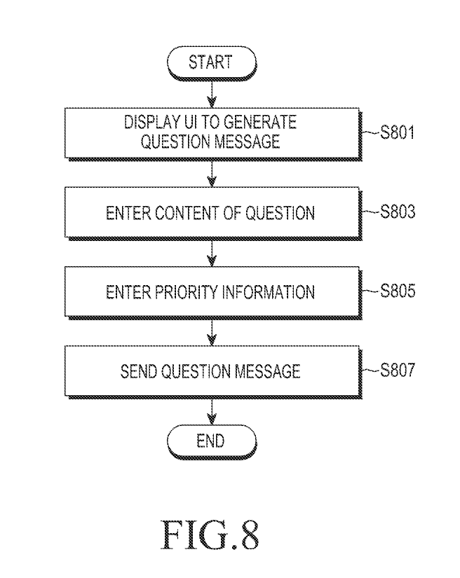

FIG. 8 is a flowchart of operation of a method of controlling a client electronic device, according to another embodiment of the present disclosure.

Referring to FIG. 8, in operation S801, the client electronic device 200 may display a user interface to create a question message. In operation S803, the client electronic device 200 may receive content of a question that is entered, or inputted, into the client electronic device 200. In operation S805, the client electronic device 200 may also receive priority information, regarding the input content of the question that is entered, or inputted, into the client electronic device 200. The priority information may indicate a level of importance of the question and may include, for example, information about a request to modify a simple typographic error or drawing, a normal question or a question to be answered quickly, or any other similar and/or suitable information. In operation S807, the client electronic device 200 may send the question message to at least one of other users and the host electronic device 100, or any other similar and/or suitable destination and/or device.

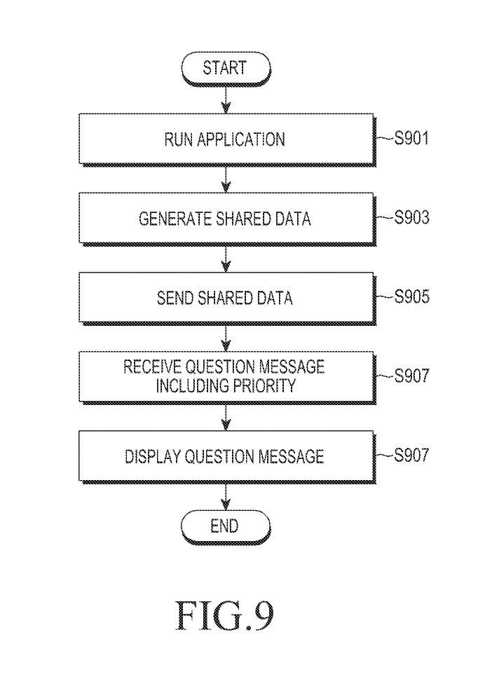

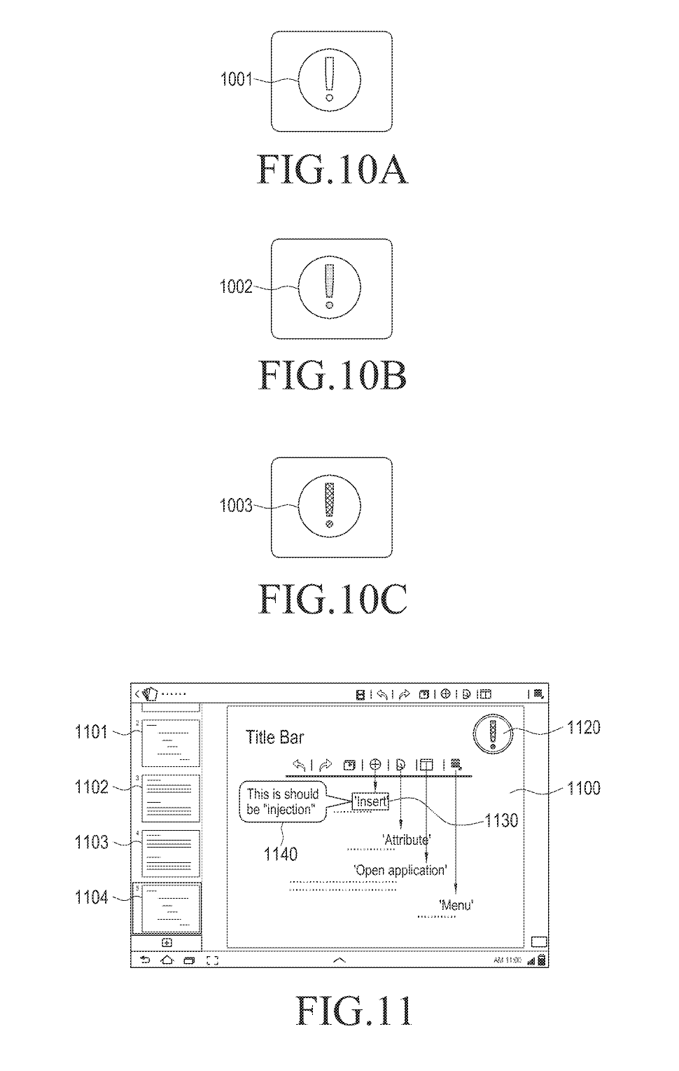

FIG. 9 is a flowchart of operation of a method of controlling a host electronic device, according to another embodiment of the present disclosure; and FIGS. 10A, 10B, and 10C illustrate icons to indicate reception of a question according to embodiments of the present disclosure.

Referring to FIG. 9, in operation S901, the host electronic device 100 may run an application to be shared, and in operation S903, may generate shared data. In operation S905, the host electronic device 100 may send the shared data to the client electronic device 200, and in operation S907 may receive a question message with a priority. In operation S909, the host electronic device 100 may analyze the question message and display the question message according to the priority.

Referring to FIGS. 10A, 10B, and 10C, the host electronic device 100 may display an icon in order to indicate reception of a question by reflecting the priority of the question message. For example, if the priority corresponds to a request to modify a simple typographic error or drawing, the host electronic device 100 may display an icon 1001 to indicate reception of a question as shown in FIG. 10A. In another example, if the priority corresponds to a normal question, the host electronic device 100 may display an icon 1002 to indicate reception of a question as shown in FIG. 10B. In yet another example, if the priority corresponds to a question to be answered quickly, the host electronic device 100 may display an icon 1003 to indicate reception of a question as shown in FIG. 10C.

FIG. 11 illustrates a screen for explaining a way of displaying a question message, according to an embodiment of the present disclosure.

Referring to FIG. 11, the host electronic device 100 may generate a question slide 1104 corresponding to a question message. The host electronic device 100 may place the question slide 1104 in the back of existing slides 1101 to 1103. This is by way of example only, and the host electronic device 100 may determine the position to place the question slide 1104 to be anywhere. For example, if the priority of the question message corresponds to a question to be answered quickly, the host electronic device 100 may place the question slide next to a slide being currently displayed so that a screen of the question slide is displayed right after the current slide is finished.

As shown in FIG. 11, the host electronic device 100 may display a screen 1100 of the question slide 1104. The screen 1100 of the question slide 1104 may include an icon 1120 in order to indicate reception of at least one of a question message, an object 1130 to be questioned, and content of a question 1140. From the screen 1100 of the question slide 1104, the user of the host electronic device 100 may identify what is entered, by a questioner or a participant, to the client electronic device 200.

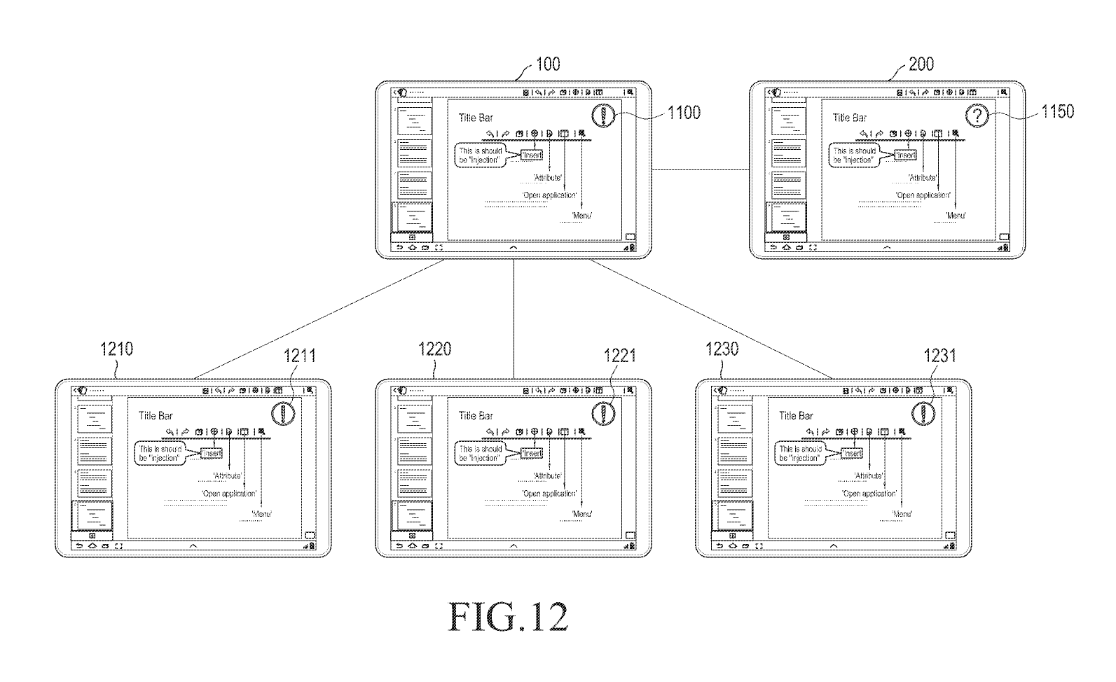

FIG. 12 illustrates electronic devices, according to an embodiment of the present disclosure.

Referring to FIG. 12, the host electronic device 100 may receive, from the client electronic device 200, and display a question message. The host electronic device 100 may display the screen 1100 based on the question message. The client electronic device 200 may display a user interface 1150 to generate a question message. The host electronic device 100 may forward the screen 1100 to other electronic devices 1210, 1220, and 1230 other than the client electronic device 200. The other electronic devices 1210, 1220, and 1230 may display respective screens 1211, 1221, and 1231 which are identical to the screen 1100.

According to various embodiments of the present disclosure, an electronic device for sharing a question message and method of controlling the electronic device is provided. The electronic device enables more efficient meeting progress by sharing question messages that reflect priorities. The electronic device also enables more accurate meeting progress by generating and displaying a question message to be shared in a particular page and/or slide.

It will be appreciated that the embodiments of the present disclosure may be implemented in a form of hardware, software, or a combination of hardware and software. The software may be stored as program instructions or computer readable codes executable on the processor on a non-transitory computer-readable medium. Examples of the non-transitory computer readable recording medium include magnetic storage media, e.g., a ROM, floppy disks, hard disks, integrated circuits, or other similar and/or suitable magnetic storage media, and optical recording media, e.g., a Compact Disk (CD) Read Only Memory (CD-ROM), a Digital Versatile Disk (DVD), or other similar and/or suitable optical recoding media. The computer readable recording medium can also be distributed over network coupled computer systems so that the computer readable code is stored and executed in a distributed fashion. This media can be read by the computer, stored in the memory, and executed by the processor. The various embodiments may be implemented by a computer or portable terminal including a controller and a memory, wherein the controller may be any suitable hardware device, such as a processor, an IC, an Application Specific IC (ASIC), an Erasable Programmable Read Only Memory (EPROM), or any other similar and/or suitable hardware element, and the memory may be an example of the computer readable recording medium suitable for storing a program or programs having instructions that implement the embodiments of the present disclosure. The various embodiments may be implemented by a program having codes for embodying the apparatus and method described in claims, the program being stored in a machine or computer readable storage medium that is non-transitory. The program may be electronically carried on any medium, such as communication signals transferred via wired or wireless connection, and the present disclosure suitably includes its equivalent.

The device may receive the program from a program provider wired and/or wirelessly connected thereto, and store the program. The program provider may include a memory for storing programs having instructions to perform the embodiments of the present disclosure, information used for the embodiments of the present disclosure, etc., a communication unit for wired/wirelessly communicating with a mobile communication terminal, and a controller for sending the program to the mobile communication terminal on request or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling a host electronic device that shares a question message with a client electronic device, the method comprising:
running an application to be shared with the client electronic device and generating shared data that includes a running screen of the application;
sending the shared data to the client electronic device;
receiving a question message from the client electronic device, the question message including content of a question regarding the application; and
displaying the question message.

2. The method of claim 1, wherein the running screen of the application comprises at least one slide and a screen for each of the at least one slide.

3. The method of claim 2, wherein the displaying of the question message comprises:
generating and displaying a question slide based on the received question message; and
displaying a screen of the question slide upon selection of the question slide.

4. The method of claim 1, further comprising displaying an icon in order to indicate reception of the question message.

5. The method of claim 4, wherein the question message includes priority information that reflects a level of importance of the question message.

6. The method of claim 5, wherein the priority information corresponds to at least one of a request to modify a simple typographic error or drawing, a normal question, and a question to be answered quickly.

7. The method of claim 5, wherein the displaying of the icon in order to indicate reception of the question message comprises displaying the icon in order to indicate reception of the question message based on the priority information.

8. The method of claim 1, further comprising forwarding the question message to other electronic devices other than the client electronic device.

9. A host electronic device that shares a question message with a client electronic device, the host electronic device comprising:
a controller configured to execute an application to be shared with the client electronic device and configured to generate shared data that includes a running screen of the application;
a communication unit configured to send the shared data to the client electronic device and configured to receive a question message from the client electronic device that includes content of a question regarding the application; and
a touch screen configured to display the question message.

10. The host electronic device of claim 9, wherein the running screen of the application comprises at least one slide and a screen for each of the at least one slide.

11. The host electronic device of claim 10, wherein the controller is configured to control a question slide to be generated and displayed based on the question message, and
wherein the controller is configured to control a screen of the question slide to be displayed.

12. The host electronic device of claim 9, wherein the touch screen is configured to display an icon in order to indicate reception of the question message.

13. The host electronic device of claim 12, wherein the question message includes priority information that reflects a level of importance of the question message.

14. The host electronic device of claim 13, wherein the priority information corresponds to at least one of a request to modify a simple typographic error or drawing, a normal question, and a question to be answered quickly.

15. The host electronic device of claim 13, wherein the controller is configured to control the icon in order to indicate reception of the question message to be displayed based on the priority information.

16. The host electronic device of claim 9, wherein the communication unit is configured to forward the question message to other electronic devices other than the client electronic device.

17. A method of controlling a client electronic device that shares a question message with a host electronic device, the method comprising:
receiving shared data that includes a running screen of an application to be shared, the application running in the host electronic device;
outputting the shared data; and
displaying an icon to create a question message which is configured to provide a user interface for creating a question message regarding the shared data.

18. The method of claim 17, wherein the running screen of the application comprises at least one slide and a screen for each of the at least one slide.

19. The method of claim 17, further comprising:
upon selection of the icon, providing a user interface for creating a question message;
receiving, through the user interface, at least one of content of the question message and at least one object to be questioned; and
sending, to the host electronic device, the question message including the at least one of the content of the question message and the at least one object to be questioned.

20. The method of claim 19, wherein the receiving, through the user interface, of at least one of content of the question message and the at least one object to be questioned comprises further receiving priority information that reflects a level of importance of the question message, and
wherein sending, to the host electronic device, of the question message comprises sending the host electronic device the question message that further includes the priority information.

21. The method of claim 20, wherein the priority information corresponds to at least one of a request to modify a simple typographic error or drawing, a normal question, and a question to be answered quickly.

22. A client electronic device for sharing a question message with a host electronic device, the client electronic device comprising:
a communication unit configured to receive shared data that includes a running screen of an application to be shared, the application running in the host electronic device;
a touch screen configured to output the shared data; and
a controller configured to display an icon to create a question message which is configured to provide a user interface for creating a question message regarding the shared data.

23. The client electronic device of claim 22, wherein the running screen of the application comprises at least one slide and a screen for each of the at least one slide.

24. The client electronic device of claim 22, wherein the controller is configured to control the touch screen to provide a user interface for creating a question message upon selection of the icon,
wherein the touch screen is configured to receive, through the user interface, at least one of content of the question message and at least one object to be questioned, and
wherein the communication unit is configured to send the host electronic device the question message with the at least one of the content of the question message and the at least one object to be questioned.

25. The client electronic device of claim 24, wherein the touch screen is configured to further receive priority information that reflects a level of importance of the question message, and
wherein the communication unit is configured to send the host electronic device the question message that further includes the priority information.

26. The client electronic device of claim 25, wherein the priority information corresponds to a request to modify at least one of a simple typographic error or drawing, a normal question, and a question to be answered quickly.
